(19) United States
(12) Patent Application Publication
(10) Pub. No.: US 2008/0195721 A1
(43) Pub. Date: Aug. 14, 2008

(54) EXHIBITING METHOD OF EXHIBITION

(76) Inventors: Mei Nah Chang, Shenzhen (CN); Teng-Hue Chuo, Shenzhen (CN); Hung-Chieh Chuo, Shenzhen (CN)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/019,325

(22) Filed: Jan. 24, 2008

(30) Foreign Application Priority Data
Feb. 8, 2007 (CN) 200710073097.9

(51) Int. Cl. G06F 15/177

(52) U.S. Cl. 709/217

(57) ABSTRACT

The present invention involves exhibiting method of exhibition. Visitors visit the exhibitions or booth organized in any locale through the video network formed by connecting in turn the terminal, network exhibition platform and the online video & audio hardware devices installed at the exhibition or booth. The visitors can connect to the network exhibition platform at any place via the Internet directly, so, the high cost of traveling, accommodation is saved and the traveling time that the visitor spends on the way is completely saved. It solves the technical problems that the existing methods need to spend a lot of time, cost and is not suitable for poor physical people. It also settles the exhibition restriction, obstacles of regional/national/time, and even more exhibitors can increase the number of visitors and improve the effectiveness of information dissemination. This method makes the technology to achieve the desired realm and many people can benefit from it.

### FIELD OF THE INVENTION

The present invention involves exhibiting method of exhibition.

### BACKGROUND OF THE INVENTION

In the existing exhibiting methods of exhibition, to get the information of every exhibiting booth in an exhibition, visitors need being at the locales of the exhibitions to visit each of the exhibiting booths one by one. In this kind of exhibitions, visitors are limited to the time and locales restriction of the exhibition, need to spend the high cost of traveling, accommodation and visit expense, and also cost a lot of traveling time, which is not suitable for poor physical people and people without so much time, so, above said restrictions decrease the number of visitors and weaken the effectiveness of the exhibitions.

### SUMMARY OF THE INVENTION

The present invention provides exhibiting method of exhibition, solving the technical problems that the existing exhibiting methods of exhibition need to take the visitors a lot of time, cost and is not suitable for poor physical people.

To solve above said technical problems, the present invention provides:

An exhibiting method of exhibition includes, visitors visit the exhibition or exhibiting booth through a video network, said video network is formed by connecting in turn terminals, exhibition network platform and online video & audio hardware devices installed at the exhibition or exhibiting booth.

Comprising steps of:

Step 1, transmitting live program of the exhibition and/or exhibiting booth via CCD camera and network to the exhibition network platform; installing video & audio hardware devices at the exhibition and/or exhibiting booth, transmitting live program of the exhibition and/or exhibiting booth to the exhibition network platform via the video & audio hardware devices and network;

Step 2, visitors visit the exhibition network platform through the terminals and network.

Wherein said visitors according to their own request can two-way communicate with the staffs at the exhibition and/or exhibiting booth.

Wherein said exhibition network platform can connect with many visitors' terminals at the same time and support them to view the live program at the same time.

Wherein each exhibiting booth in said exhibition has video & audio hardware devices installed, visitors can select any exhibiting booth to visit.

Wherein said visitors need to register and pay to get password before entering the exhibition network platform, visitors can only enter the exhibition network platform after their password is validated.

Wherein said video & audio hardware devices record video & audio data, which are stored in the storage devices of exhibition network platform, for the visitors to play or download.

Wherein said exhibition network platform can work out a report of data analysis and classification statistics according to visitors' information.

After applying above said technical solution, because the visitors can connect to the network exhibition platform at any place via the Internet directly, so, the high cost of traveling, accommodation is saved and the traveling time that the visitor spends on the way is completely saved. It solves the technical problems that the existing methods need to spend a lot of time, cost and is not suitable for poor physical people. Using above said method, visitors can according to their own request select any favor time, locales to visit exhibitions. Visitors can not only save time and money, while achieving the same effect as visiting at the locale of the exhibition, but also can according their needs to download video and audio data of visiting and keep the records of visited exhibition. And the exhibiting method of exhibition is suitable for poor physical people such as the elderly, the weak, the sick people and women and children, it also avoids restriction of regional, national, time and weather, and because it can gain the visitors from Internet, effectiveness of the exhibition is highly improved. By this exhibiting method of exhibiting booth with live program, exhibitions will break the restriction of regional/time. Benefit and essential request of exhibitions are increased. This method will make exhibitions without national restriction, and more meaningful. The embodiment of this method is composed of software system and corresponding hardware devices.

### BRIEF DESCRIPTION OF THE DRAWINGS

FIG. 1 is a network diagrammatic drawing describing an embodiment of the present invention.

### DESCRIPTION OF THE PREFERRED EMBODIMENT

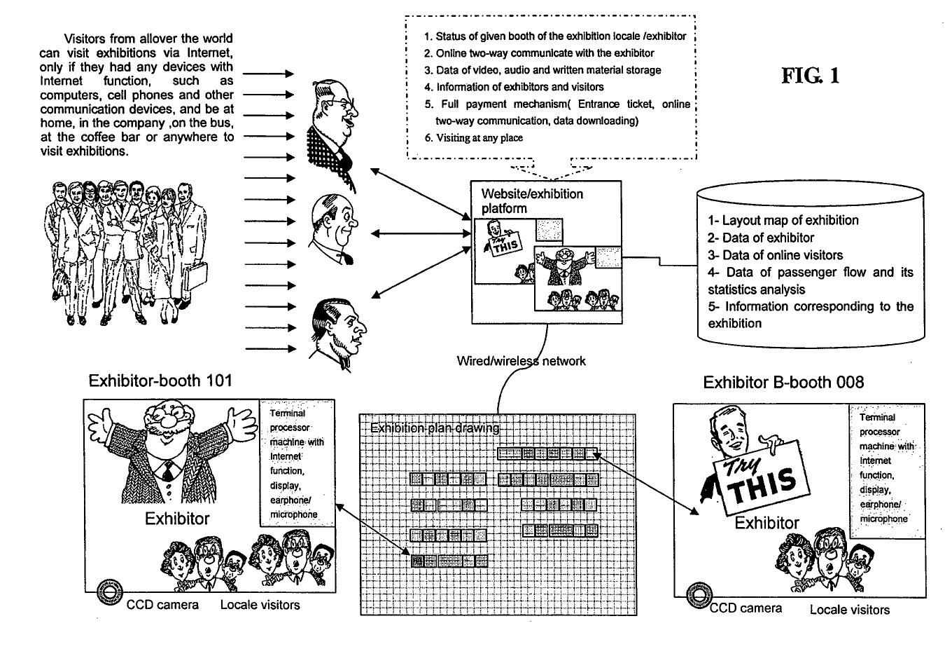

As shown in FIG. 1, in the exhibiting method of exhibition, visitors visit the exhibition or exhibiting booth through a video network, said video network is formed by connecting in turn terminals, exhibition network platform and online video & audio hardware devices installed at the exhibition or exhibiting booth, comprising the steps of:

Step 1, transmitting live program of the exhibition and/or exhibiting booth via CCD camera and network to the exhibition network platform; installing video & audio hardware devices at the exhibition and/or exhibiting booth, transmitting live program of the exhibition and/or exhibiting booth to the exhibition network platform via the video & audio hardware devices and network;

Step 2, visitors visit the exhibition network platform through the terminals and network.

Wherein each exhibiting booth in said exhibition has video & audio hardware devices installed, visitors can select any exhibiting booth to visit. Via wireless communication or wired communication, video & audio hardware devices and exhibition network platform are connected, and so are terminals for visitors and exhibition network platform. Visitors according to their own request can two-way communicate with the staffs at the exhibition and/or exhibiting booth. The exhibition network platform can work out a report of data analysis and classification statistics according to visitors' information. It also can connect with many visitors' terminals at the same time and support them to view the live program at the same time. Visitors need to register and pay to get password before entering the exhibition network platform, visitors can only enter the exhibition network platform after their password is validated. The video & audio hardware devices record video & audio data, which are stored in the storage devices of exhibition network platform, for the visitors to play or download. The exhibition network platform also stores information such as map location of exhibition and/or exhibiting booth for the visitors to play and download. Using above said method, visitors can according to their own request select any favor time, locales to visit exhibitions. Visitors can not only save time and money, while achieving the same effect as visiting at the locale of the exhibition, but also can according their needs to download video and audio data of visiting and keep the records of visited exhibition. And the exhibiting method of exhibition is suitable for poor physical people such as the elderly, the weak, the sick people and women and children, it also avoids restriction of regional, national, time and weather. The exhibition network platform is a network assembly special platform, congregating many of or even all of exhibitions and/or exhibiting booths in the word which are able to visit online through video network. The terminals can be devices with function of video and Internet, comprising display, processor and earphone, such as computers or TVs with Set-Top Box and earphone, or cell phones with function of visiting wireless network. The video & audio hardware devices comprise CCD camera, processor with Internet function, display, earphone, speaker and microphone.

What is claimed is:

1. An exhibiting method of exhibition comprising, visitors visiting the exhibition or exhibiting booth through a video network, said video network formed by connecting in turn terminals, exhibition network platform and online video & audio hardware devices installed at the exhibition or exhibiting booth.

2. The exhibiting method of exhibition of claim 1, wherein each exhibiting booth in said exhibition has video & audio hardware devices installed, visitors can select any exhibiting booth to visit.

3. The exhibiting method of exhibition of claim 2, wherein said exhibition network platform can work out a report of data analysis and classification statistics according to visitors' information.

4. The exhibiting method of exhibition of claim 1, wherein said visitors need to register and pay to get password before entering the exhibition network platform, visitors can only enter the exhibition network platform after their password is validated.

5. The exhibiting method of exhibition of claim 1, wherein said video & audio hardware devices record video & audio data, which are stored in the storage devices of exhibition network platform, for the visitors to play or download.

6. The exhibiting method of exhibition of claim 1, wherein comprising:
Step 1, transmitting live program of the exhibition and/or exhibiting booth via CCD camera and network to the exhibition network platform; installing video & audio hardware devices at the exhibition and/or exhibiting booth, transmitting live program of the exhibition and/or exhibiting booth to the exhibition network platform via the video & audio hardware devices and network;
Step 2, visitors visiting the exhibition network platform through the terminals and network.

7. The exhibiting method of exhibition of claim 6, wherein each exhibiting booth in said exhibition has video & audio hardware devices installed, visitors can select any exhibiting booth to visit.

8. The exhibiting method of exhibition of claim 7, wherein said exhibition network platform can work out a report of data analysis and classification statistics according to visitors' information.

9. The exhibiting method of exhibition of claim 6, wherein said visitors need to register and pay to get password before entering the exhibition network platform, visitors can only enter the exhibition network platform after their password is validated.

10. The exhibiting method of exhibition of claim 6, wherein said video & audio hardware devices record video & audio data, which are stored in the storage devices of exhibition network platform, for the visitors to play or download.

11. The exhibiting method of exhibition of claim 6, wherein said visitors according to their own request can two-way communicate with the staffs at the exhibition and/or exhibiting booth.

12. The exhibiting method of exhibition of claim 11, wherein each exhibiting booth in said exhibition has video & audio hardware devices installed, visitors can select any exhibiting booth to visit.

13. The exhibiting method of exhibition of claim 12, wherein said exhibition network platform can work out a report of data analysis and classification statistics according to visitors' information.

14. The exhibiting method of exhibition of claim 11, wherein said visitors need to register and pay to get password before entering the exhibition network platform, visitors can only enter the exhibition network platform after their password is validated.

15. The exhibiting method of exhibition of claim 11, wherein said video & audio hardware devices record video & audio data, which are stored in the storage devices of exhibition network platform, for the visitors to play or download.

16. The exhibiting method of exhibition of claim 11, wherein said exhibition network platform can connect with many visitors' terminals at the same time and support them to view the live program at the same time.

17. The exhibiting method of exhibition of claim 16, wherein each exhibiting booth in said exhibition has video & audio hardware devices installed, visitors can select any exhibiting booth to visit.

18. The exhibiting method of exhibition of claim 17, wherein said exhibition network platform can work out a report of data analysis and classification statistics according to visitors' information.

19. The exhibiting method of exhibition of claim 17, wherein said visitors need to register and pay to get password before entering the exhibition network platform, visitors can only enter the exhibition network platform after their password is validated.

20. The exhibiting method of exhibition of claim 17, wherein said video & audio hardware devices record video & audio data, which are stored in the storage devices of exhibition network platform, for the visitors to play or download.
